(19) United States
(12) Patent Application Publication
(10) Pub. No.: US 2009/0243996 A1
(43) Pub. Date: Oct. 1, 2009

(54) ELECTROPHORETIC DISPLAY DEVICE, METHOD OF DRIVING THE SAME, AND ELECTRONIC APPARATUS

(75) Inventor: Toshimichi Yamada, Suwa-gun (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/389,625

(22) Filed: Feb. 20, 2009

(30) Foreign Application Priority Data
Mar. 27, 2008 (JP) 2008-083236

(51) Int. Cl. G09G 3/34

(52) U.S. Cl. 345/107

(57) ABSTRACT

A method of driving an electrophoretic display device that includes a display unit that includes a plurality of pixels is provided. Each of the pixels includes a pair of a pixel electrode and a common electrode; an electrophoretic element that is driven on the basis of a potential difference between the pixel electrode and the common electrode; a pixel switching element; a memory circuit; and a switch circuit. The method includes: writing an image signal to the memory circuit through the pixel switching element; and displaying a predetermined image on the display unit by performing a switching control by the switch circuit in accordance with an output based on the image signal of the memory circuit to supply a predetermined potential to the pixel electrode. At least when the electrophoretic element is driven in accordance with an external input from outside of the electrophoretic display device, the predetermined image is displayed on the display unit in parallel with the writing of the image signal to the memory circuit at the same time.

### BACKGROUND

1. Technical Field

The invention relates to a technical field of an electrophoretic display device, a method of driving the electrophoretic display device, and an electronic apparatus.

2. Related Art

An electrophoretic display device of this type includes a display unit that displays an image in the following manner with a plurality of pixels. In each pixel, after an image signal is written to a memory circuit through a pixel switching element, a pixel electrode is driven by a potential corresponding to the written image signal to thereby generate a potential difference with respect to a common electrode. This drives an electrophoretic element between the pixel electrode and the common electrode to perform display. For example, JP-A-2003-84314 describes a configuration that the pixel includes a DRAM (Dynamic Random Access Memory) or an SRAM (Static Random Access Memory) in a memory circuit.

Alternatively, according to the research conducted by the inventors of the application, in order to drive an electrophoretic element, a pixel circuit having not only a memory circuit that includes a pixel switching element and an SRAM but also a switch circuit is formed in each pixel, and the pixel circuit performs display on a display unit. The pixel circuit is able to perform, separately from (i) writing of an image signal in the memory circuit, (ii) supply of a potential to a pixel electrode. According to the above pixel circuit, in comparison with the pixel circuit described in JP-A-2003-84314, it is possible to drive each pixel at a low power consumption, and it is possible to further effectively prevent occurrence of leakage current between adjacent pixels of which the pixel electrodes are applied with different potentials from each other.

However, according to the display operation by which the above (i) and (ii) are separately performed as described above, it is difficult to perform quick response display when external input, such as pen input, is performed outside of an electrophoretic display device equipped with a pen tablet or a touch sensor. That is, when an electrophoretic element is driven in response to external input, the length of time required for the above (i) and (ii) elongates and, therefore, a frame rate slows. Thus, the contents corresponding to external input is displayed with a delay from an input operation.

### SUMMARY

An aspect of the invention provides a method of driving an electrophoretic display device. The electrophoretic display device includes a display unit that includes a plurality of pixels. Each of the pixels includes a pair of a pixel electrode and a common electrode; an electrophoretic element that is driven on the basis of a potential difference between the pixel electrode and the common electrode; a pixel switching element; a memory circuit; and a switch circuit. The method includes: writing an image signal to the memory circuit through the pixel switching element; and displaying a predetermined image on the display unit by performing a switching control by the switch circuit in accordance with an output based on the image signal of the memory circuit to supply a predetermined potential to the pixel electrode. At least when the electrophoretic element is driven in accordance with an external input from outside of the electrophoretic display device, the predetermined image is displayed on the display unit in parallel with the writing of the image signal to the memory circuit at the same time.

In the method of driving the electrophoretic display device according to the aspect of the invention, an image signal is written to the memory circuit and a predetermined image is displayed on the display unit. Thus, a voltage based on a potential difference between the pixel electrode and the common electrode in each of the plurality of pixels included in the display unit is applied to the electrophoretic element. Thus, by moving electrophoretic particles contained in the electrophoretic element between the pixel electrode and the common electrode, an image is displayed on the display unit.

First, in each pixel, an image signal is written through the pixel switching element to the memory circuit and, subsequently, in each pixel, switching control is performed on the pixel electrode by the switch circuit in accordance with an output from the memory circuit based on the held image signal to thereby supply a predetermined potential to the pixel electrode.

In the aspect of the invention, at least when the electrophoretic display device is equipped with a pen tablet or a touch sensor and then an external input, such as a pen input, is performed, displaying a predetermined image on the display unit is performed in parallel with writing an image signal to the memory circuit. In a case other than an external input, displaying a predetermined image on the display unit is separately performed from writing an image signal to the memory circuit. When displaying a predetermined image on the display unit is separately performed from writing an image signal to the memory circuit, it is advantageous in that, by driving the memory circuit at different voltages in the respective operations, display may be performed at a low power consumption, and, in displaying a predetermined image on the display unit, a predetermined potential is supplied to the pixel electrode in each pixel included in the display unit to thereby make it possible to switch display.

On the other hand, at the time of external input, in parallel with an image signal supplied in accordance with an external input is written to the memory circuit, an output based on the image signal is performed from the memory circuit, and switching control is performed by the switch circuit. As a result, in parallel with writing of an image signal to the memory circuit, the pixel electrode is supplied with a predetermined potential. Thus, it is possible to display the contents corresponding to an external input.

Thus, in comparison with the case in which writing of an image signal to the memory circuit is separately performed from displaying of a predetermined image on the display unit, it is possible to reduce the length of time for writing of an image signal to the memory circuit and displaying of a predetermined image on the display unit at the time of external input. Hence, it is possible to quickly display the contents corresponding to the input. As a result, in synchronization with an external input, an image in response to the contents of the input may be displayed.

The method of driving the electrophoretic display device according to the aspect of the invention may further include supplying a boosted power supply voltage to the memory circuit between when the image signal is written to the memory circuit and when the predetermined image is displayed on the display unit, wherein the boosted power supply voltage may not be supplied to the memory circuit at least when the external input is performed.

According to this aspect, when the image signal is written to the memory circuit, typically, a minimum power supply voltage required for driving the memory circuit is supplied, and the predetermined image is displayed on the display unit after the power supply voltage is boosted up in order to apply a predetermined potential difference between the pixel electrode and the common electrode. Thus, in comparison with the case in which the memory circuit is constantly driven at a voltage required to apply a predetermined potential difference between the pixel electrode and the common electrode, it is possible to perform a display operation at a further low power consumption.

Furthermore, at least when an external input is performed, the power supply voltage is not boosted up, and the memory circuit is driven at a predetermined power supply voltage (for example, a minimum power supply voltage required for driving) when an image signal is written to the memory circuit and when a predetermined image is displayed on the display unit. Thus, it is possible to perform both writing of an image signal to the memory circuit and displaying of a predetermined image on the display unit in parallel with each other at a low power consumption.

In the method of driving the electrophoretic display device according to the aspect of the invention, when the predetermined is displayed on the display unit, any one of the first and second potentials may be supplied through the switch circuit to the pixel electrode by the switching control, while, at least at the time of the external input, the common electrode may be supplied with a common potential so that a potential difference occurs between the common potential and only any one of the first and second potentials.

According to this aspect, when the predetermined image is displayed on the display unit, any one of the first and second potentials are selected by the switching control and supplied through the switch circuit to the pixel electrode. Here, the first and second potentials are potentials different from each other, and, for example, the first potential is set to a high level that is higher in potential than the second potential (low level). Thus, by driving the pixel electrode with mutually different first and second potentials in each pixel, it is possible to perform display of different colors, for example, white display or black display, at the respective potentials on the basis of a potential difference between the pixel electrode and the common electrode.

Furthermore, at least at the time of the external input, the common potential is supplied so that a potential difference occurs between the common potential and one of the first and second potentials. Thus, in each pixel, one of the first and second potentials, which is different in potential from the common potential, is supplied through the switch circuit to the pixel electrode to thereby, for example, perform only one of white display and black display. At this time, when an image signal is written to the memory circuit, the image signal is written so that, in only portion of the plurality of pixels, located at portions required to change the display contents in accordance with the external input, one of the first and second potentials, which is different in potential from the common potential, is supplied to the pixel electrode. Thus, in response to the external input, it is possible to change the display contents using one of black display and white display only partially necessary portions on the display unit. Thus, in comparison with the case in which display is switched in accordance with the input contents by, for example, both white display and black display on the entire display unit at the time of external input, it is possible to further quickly perform display.

Another aspect of the invention provides an electrophoretic display device that is driven by the method of driving the electrophoretic display device according to the aspect of the invention (including its various aspects).

According to the electrophoretic display device of the aspect of the invention, because image display is performed on the display unit by the driving method according to the above described aspect of the invention, it is possible to quickly perform display in response to an external input.

Further another aspect of the invention provides an electronic apparatus that includes the electrophoretic display device according to the aspect of the invention.

According to the electronic apparatus of the aspect of the invention, because the electrophoretic display device according to the aspect of the invention is provided, it is possible to implement various electronic apparatuses that are able to quickly perform display in response to an external input, such as a watch, an electronic paper, an electronic notebook, a cellular phone, or a portable audio device.

The function and other advantageous effects of the aspects of the invention will become apparent from an embodiment described below.

### BRIEF DESCRIPTION OF THE DRAWINGS

The invention will be described with reference to the accompanying drawings, wherein like numbers reference like elements.

FIG. 1 is a block diagram that shows the overall configuration of an electrophoretic display device according to an embodiment.

FIG. 2 is an equivalent circuit diagram that shows the electrical configuration of a pixel.

FIG. 3 is a partially cross-sectional view of a display unit of the electrophoretic display device according to the embodiment.

FIG. 4 is a schematic view that shows the configuration of a microcapsule.

FIG. 5 is a timing chart that schematically shows the waveforms of various signals when an external input is performed.

FIG. 6 is a perspective view that shows the configuration of an electronic paper, which is an example of an electronic apparatus to which the electrophoretic display device is applied.

FIG. 7 is a perspective view that shows the configuration of an electronic notebook, which is an example of an electronic apparatus to which the electrophoretic display device is applied.

### DESCRIPTION OF EXEMPLARY EMBODIMENTS

Hereinafter, an embodiment of the invention will be described with reference to the accompanying drawings.

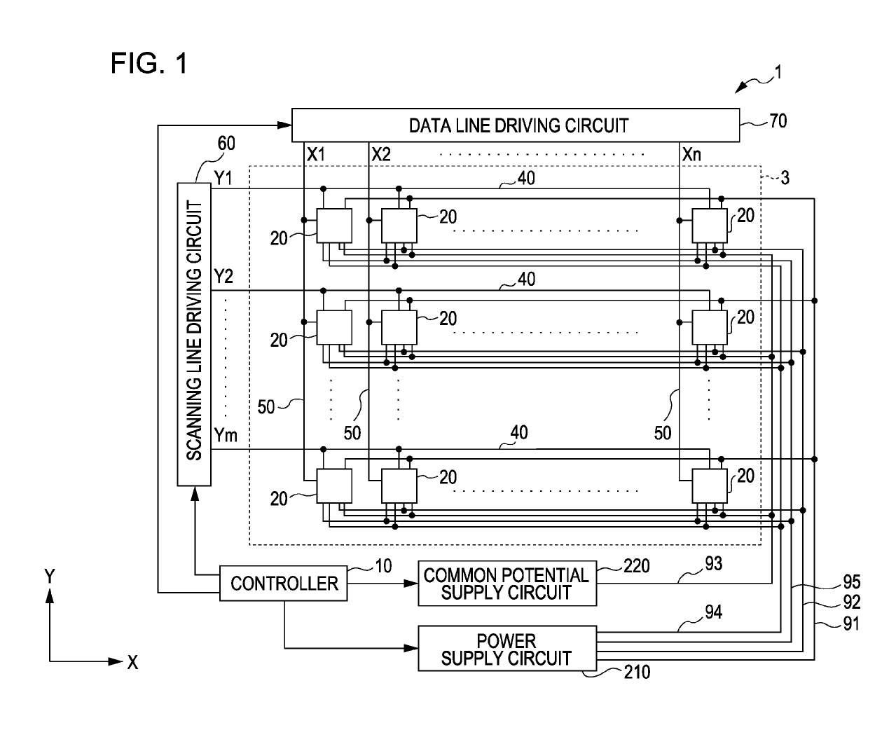

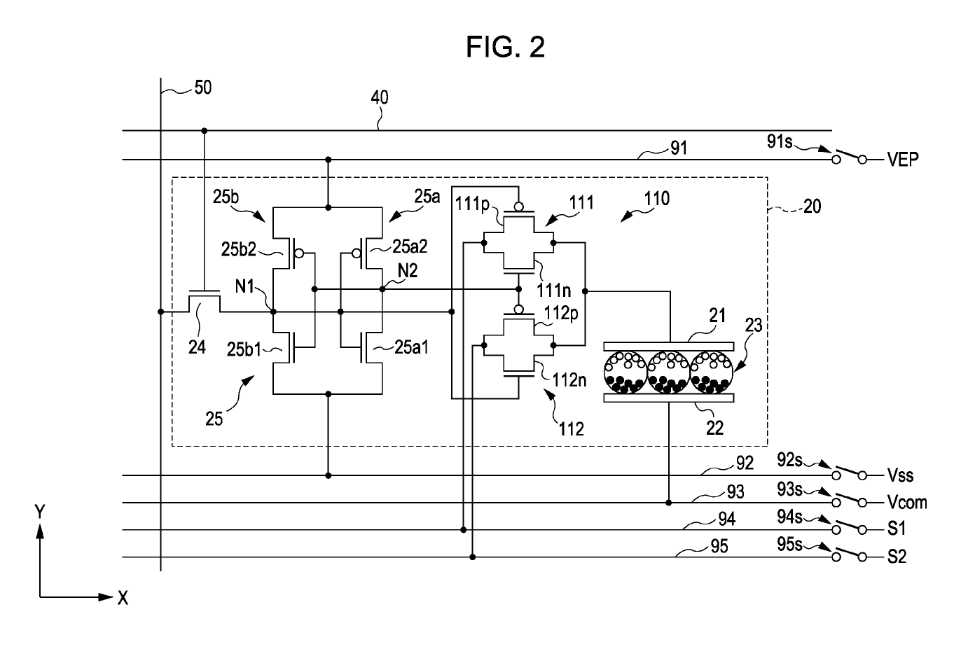

First, the overall configuration of an electrophoretic display device according to the present embodiment will be described with reference to FIG. 1 and FIG. 2.

FIG. 1 is a block diagram that shows the overall configuration of the electrophoretic display device according to the present embodiment.

As shown in FIG. 1, the electrophoretic display device 1 according to the present embodiment includes a display unit 3, a controller 10, a scanning line driving circuit 60, a data line driving circuit 70, a power supply circuit 210, and a common potential supply circuit 220.

In the display unit 3, pixels 20 are arranged in a matrix (in a two-dimensional plane) of m rows and n columns.

In addition, m scanning lines 40 (that is, scanning lines Y1, Y2, . . . , Ym) and n data lines 50 (that is, data lines X1, X2, . . . , Xn) are provided in the display unit 3 so as to intersect with one another. Specifically, the m scanning lines 40 extend horizontally (that is, X direction), and the n data lines 50 extend vertically (that is, Y direction). The pixels 20 are arranged at positions corresponding to intersections of the m scanning lines 40 and the n data lines 50.

The controller 10 controls operations of the scanning line driving circuit 60, data line driving circuit 70, power supply circuit 210 and common potential supply circuit 220. The controller 10, for example, supplies a timing signal, such as a clock signal or a start pulse, to each circuit.

The scanning line driving circuit 60 sequentially supplies a scanning signal to each of the scanning lines Y1, Y2, . . . , Ym in a pulse-like manner on the basis of the timing signal supplied from the controller 10.

The data line driving circuit 70 supplies image signals to the data lines X1, X2, . . . , Xn on the basis of the timing signal supplied from the controller 10. Each image signal holds a binary level, that is, a high-potential level (hereinafter, referred to as “high level”, for example, V) or a low-potential level (hereinafter, referred to as “low level”, for example, 0 V).

The power supply circuit 210 supplies a high-potential power supply line 91 with a high-potential power supply potential VEP, supplies a low-potential power supply line 92 with a low-potential power supply potential Vss, supplies a first control line 94 with a first potential S1, and supplies a second control line 95 with a second potential S2. Although not shown in the drawing, the high-potential power supply line 91, the low-potential power supply line 92, the first control line 94 and the second control line 95 each are electrically connected to the power supply circuit 210 through an electrical switch.

The common potential supply circuit 220 supplies a common potential line 93 with a common potential Vcom.

Although not shown in the drawing, the common potential line 93 is electrically connected to the common potential supply circuit 220 through an electrical switch.

Note that various signals are input to or output from the controller 10, the scanning line driving circuit 60, the data line driving circuit 70, the power supply circuit 210 and the common potential supply circuit 220; however, signals that are not related to the present embodiment will not be described.

FIG. 2 is an equivalent circuit diagram that shows the electrical configuration of a pixel.

As shown in FIG. 2, each pixel 20 includes a pixel switching transistor 24, which is an example of “pixel switching element” according to the aspects of the invention, a memory circuit 25, a switch circuit 110, a pixel electrode 21, a common electrode 22, and an electrophoretic element 23.

The pixel switching transistor 24 is, for example, formed of an N-type transistor. The gate of the pixel switching transistor 24 is electrically connected to the scanning line 40, the source thereof is electrically connected to the data line 50, and the drain thereof is electrically connected to an input terminal N1 of the memory circuit 25. The pixel switching transistor 24 outputs the image signal, supplied from the data line driving circuit 70 (see FIG. 1) through the data line 50, to the input terminal N1 of the memory circuit 25 at the timing based on the scanning signal supplied in a pulse-like manner from the scanning line driving circuit 60 (see FIG. 1) through the scanning line 40.

The memory circuit 25 includes inverter circuits 25a and 25b, and is formed as an SRAM.

The inverter circuits 25a and 25b form a loop structure such that the input terminals are connected to the output terminals of the other one. That is, the input terminal of the inverter circuit 25a is electrically connected to the output terminal of the inverter circuit 25b, and the input terminal of the inverter circuit 25b is electrically connected to the output terminal of the inverter circuit 25a. The input terminal of the inverter circuit 25a is formed as the input terminal N1 of the memory circuit 25. The output terminal of the inverter circuit 25a is formed as the output terminal N2 of the memory circuit 25.

The inverter circuit 25a has an N-type transistor 25a1 and a P-type transistor 25a2. The gates of the N-type transistor 25a1 and P-type transistor 25a2 are electrically connected to the input terminal N1 of the memory circuit 25. The source of the N-type transistor 25a1 is electrically connected to the low-potential power supply line 92 to which a low-potential power supply potential Vss is supplied. The source of the P-type transistor 25a2 is electrically connected to the high-potential power supply line 91 to which a high-potential power supply potential VEP is supplied. The drains of the N-type transistor 25a1 and P-type transistor 25a2 are electrically connected to the output terminal N2 of the memory circuit 25.

The inverter circuit 25b has an N-type transistor 25b1 and a P-type transistor 25b2. The gates of the N-type transistor 25b1 and P-type transistor 25b2 are electrically connected to the output terminal N2 of the memory circuit 25. The source of the N-type transistor 25b1 is electrically connected to the low-potential power supply line 92 to which the low-potential power supply potential Vss is supplied. The source of the P-type transistor 25b2 is electrically connected to the high-potential power supply line 91 to which the high-potential power supply potential VEP is supplied. The drains of the N-type transistor 25b1 and P-type transistor 25b2 are electrically connected to the input terminal N1 of the memory circuit 25.

When a high-level image signal is input to the input terminal N1 of the memory circuit 25, the memory circuit 25 outputs the low-potential power supply potential Vss from the output terminal N2. When a low-level image signal is input to the input terminal N1 of the memory circuit 25, the memory circuit 25 outputs the high-potential power supply potential VEP from the output terminal N2. That is, the memory circuit 25 outputs the low-potential power supply potential Vss or the high-potential power supply potential VEP on the basis of whether the input image signal is at a high level or at a low level. In other words, the memory circuit 25 is able to store the input image signal as the low-potential power supply potential Vss or the high-potential power supply potential VEP.

The high-potential power supply line 91 and the low-potential power supply line 92 are respectively able to supply the high-potential power supply potential VEP and the low-potential power supply potential Vss from the power supply circuit 210. The high-potential power supply line 91 is electrically connected through a switch 91s to the power supply circuit 210. The low-potential power supply line 92 is electrically connected through a switch 92s to the power supply circuit 210. Each of the switches 91s and 92s may be switched between an on state and an off state by the controller 10. When the switch 91s turns on, the high-potential power supply line 91 is electrically connected to the power supply circuit 210. When the switch 91s turns off, the high-potential power supply line 91 is electrically disconnected to enter a high impedance state. When the switch 92s turns on, the low-potential power supply line 92 is electrically connected to the power supply circuit 210. When the switch 92s turns off, the low-potential power supply line 91 is electrically disconnected to enter a high impedance state.

The switch circuit 110 includes a first transmission gate 111 and a second transmission gate 112. The first transmission gate 111 includes a P-type transistor 111p and an N-type transistor 111n. The sources of the P-type transistor 111p and N-type transistor 111n are electrically connected to the first control line 94. The drains of the P-type transistor hip and N-type transistor 111n are electrically connected to the pixel electrode 21. The gate of the P-type transistor 111p is electrically connected to the input terminal N1 of the memory circuit 25. The gate of the N-type transistor 111n is electrically connected to the output terminal N2 of the memory circuit 25.

The second transmission gate 112 has a P-type transistor 112p and an N-type transistor 112n. The sources of the P-type transistor 112p and N-type transistor 112n are electrically connected to the second control line 95. The drains of the P-type transistor 112p and N-type transistor 112n are electrically connected to the pixel electrode 21. The gate of the P-type transistor 112p is electrically connected to the output terminal N2 of the memory circuit 25. The gate of the N-type transistor 112n is electrically connected to the input terminal N1 of the memory circuit 25.

The switch circuit 110 selects any one of the first control line 94 and the second control line 95 on the basis of the image signal input to the memory circuit 25, and electrically connects the one of the control lines to the pixel electrode 21.

Specifically, when a high-level image signal is input to the input terminal N1 of the memory circuit 25, the low-potential power supply potential Vss is output from the memory circuit 25 to the gates of the N-type transistor 111n and P-type transistor 112p, and the high-potential power supply potential VEP is output from the memory circuit 25 to the gates of the P-type transistor 111p and N-type transistor 112n. Thus, only the P-type transistor 112p and the N-type transistor 112n that constitute the second transmission gate 112 turn on, and the P-type transistor 111p and the N-type transistor 111n that constitute the first transmission gate 111 turn off. On the other hand, when a low-level image signal is input to the input terminal N1 of the memory circuit 25, the high-potential power supply potential VEP is output from the memory circuit 25 to the gates of the N-type transistor 111n and P-type transistor 112p, and the low-potential power supply potential Vss is output from the memory circuit 25 to the gates of the P-type transistor 111p and N-type transistor 112n. Thus, only the P-type transistor 111p and the N-type transistor 111n that constitute the first transmission gate 111 turn on, and the P-type transistor 112p and the N-type transistor 112n that constitute the second transmission gate 112 turn off. That is, when a high-level image signal is input to the input terminal N1 of the memory circuit 25, only the second transmission gate 112 turns on, while, when a low-level image signal is input to the input terminal N1 of the memory circuit 25, only the first transmission gate 111 turns on.

The first control line 94 and the second control line 95 are respectively able to supply the first potential S1 and the second potential S2 from the power supply circuit 210. The first control line 94 is electrically connected through a switch 94s to the power supply circuit 210. The second control line 95 is electrically connected through a switch 95s to the power supply circuit 210. Each of the switches 94s and 95s may be switched between an on state and an off state by the controller 10. When the switch 94s is turned on, the first control line 94 is electrically connected to the power supply circuit 210. When the switch 94s is turned off, the first control line 94 is electrically disconnected to enter a high impedance state. When the switch 95s is turned on, the second control line 95 is electrically connected to the power supply circuit 210. When the switch 95s is turned off, the second control line 95 is electrically disconnected to enter a high impedance state.

The pixel electrode 21 of each of the plurality of pixels 20 is electrically connected to one of the control line 94 and the control line 95 selected by the switch circuit 110 on the basis of the image signal. Then, the pixel electrode 21 of each of the plurality of pixels 20 is supplied from the power supply circuit 210 with a first potential S1 or a second potential S2 or is caused to enter a high impedance state on the basis of on/off state of the switch 94s or 95s.

More specifically, in the pixel 20 to which a low-level image signal is supplied, only the first transmission gate 111 turns on, the pixel electrode 21 of the pixel 20 is electrically connected to the first control line 94, and then the first potential S1 is supplied from a power supply circuit 210 or is caused to enter a high impedance state on the basis of on/off state of the switch 94s. On the other hand, in the pixel 20 to which a high-level image signal is supplied, only the second transmission gate 112 turns on, the pixel electrode 21 of the pixel 20 is electrically connected to the second control line 95, and then the second potential S2 is supplied from the power supply circuit 210 or is caused to enter a high impedance state on the basis of on/off state of the switch 95s.

Each pixel electrode 21 is arranged so as to face the common electrode 22 through the electrophoretic element 23.

The common electrode 22 is electrically connected to the common potential line 93 to which a common potential Vcom is supplied. The common potential line 93 is able to supply the common potential Vcom from the common potential supply circuit 220. The common potential line 93 is electrically connected through a switch 93s to the common potential supply circuit 220. The switch 93s may be switched between an on state and an off state by the controller 10. When the switch 93s is turned on, the common potential line 93 is electrically connected to the common potential supply circuit 220. When the switch 93s is turned off, the common potential line 93 is electrically disconnected to enter a high impedance state.

The electrophoretic element 23 is formed of a plurality of microcapsules, each of which contains electrophoretic particles.

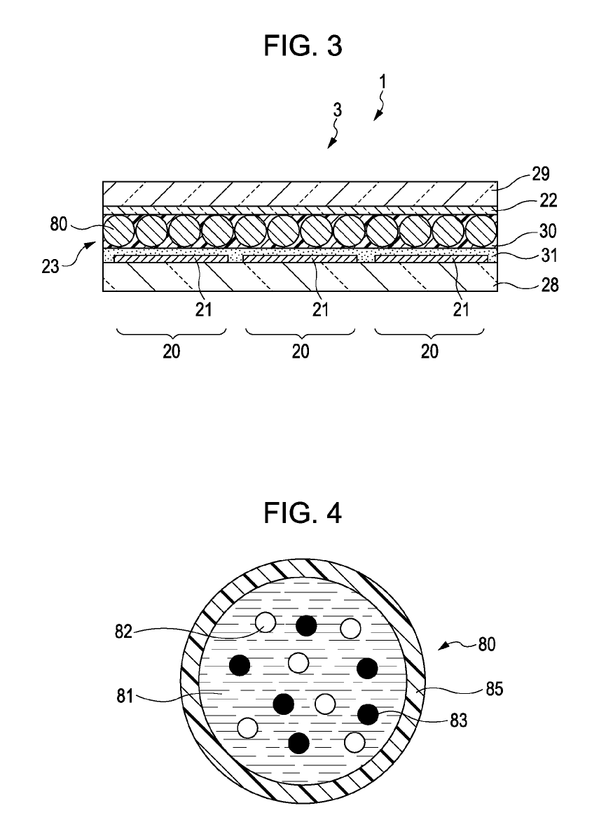

Next, a specific configuration of the display unit of the electrophoretic display device according to the present embodiment will be described with reference to FIG. 3 and FIG. 4.

FIG. 3 is a partially cross-sectional view of the display unit of the electrophoretic display device according to the present embodiment.

As shown in FIG. 3, the display unit 3 is formed so that the electrophoretic elements 23 are held between an element substrate 28 and an opposite substrate 29. Note that in the present embodiment, the description will be made on the assumption that an image is displayed on the side of the opposite substrate 29.

The element substrate 28 is a substrate made of, for example, glass, plastic, or the like. A laminated structure (not shown) is formed on the element substrate 28. The laminated structure is formed of the pixel switching transistors 24, the memory circuits 25, the switch circuits 110, the scanning lines 40, the data lines 50, the high-potential power supply lines 91, the low-potential power supply lines 92, the common potential lines 93, the first control lines 94, the second control lines 95, and the like, which are described with reference to FIG. 2. The plurality of pixel electrodes 21 are provided in a matrix at the upper layer side of the laminated structure.

The opposite substrate 29 is a transparent substrate made of, for example, glass, plastic, or the like. The common electrode 22 is formed on a surface of the opposite substrate 29, facing the element substrate 28, in a solid manner so as to face the plurality of pixel electrodes 9a. The common electrode 22 is, for example, made of a transparent conductive material, such as magnesium silver (MgAg), indium tin oxide (ITO), or indium zinc oxide (IZO).

Each electrophoretic element 23 is formed of a plurality of microcapsules 80, each of which contains electrophoretic particles, and is fixed between the element substrate 28 and the opposite substrate 29 by an adhesive layer 31 and a binder 30 made of, for example, resin, or the like. Note that the electrophoretic display device 1 according to the present embodiment is formed in a manufacturing process such that an electrophoretic sheet formed by fixing the electrophoretic elements 23 on the side of the opposite substrate 29 by the binder 30 beforehand is adhered onto the side of the element substrate 28, which is manufactured separately and on which the pixel electrodes 21, and the like, are formed by the adhesive layer 31.

The microcapsules 80 are held between the pixel electrode 21 and the common electrode 22, and one or plurality of the microcapsules 80 are arranged in one pixel 20 (in other words, for one pixel electrode 21).

FIG. 4 is a schematic view that shows the configuration of the microcapsule. Note that FIG. 4 schematically shows the cross-sectional view of the microcapsule.

As shown in FIG. 4, the microcapsule 80 is formed so that a dispersion medium 81, a plurality of white particles 82 and a plurality of black particles 83 are enclosed inside a film 85. The microcapsule 80 is, for example, formed in a spherical shape having a diameter of about 50 um. Note that the white particles 82 and the black particles 83 are an example of electrophoretic particles.

The film 85 serves as an outer shell of the microcapsule 80, and is made of a translucent polymer resin, for example, an acrylic resin such as polymethylmethacrylate or polyethylmethacrylate, urea resin, and gum arabic.

The dispersion medium 81 is a medium that disperses the white particles 82 and the black particles 83 in the microcapsule 80 (in other words, in the film 85). The dispersion medium 81 may include, for example, water, alcohol medium, such as methanol, ethanol, isopropanol, butanol, octanol, and methyl cellosolve, various esters, such as ethyl acetate, and butyl acetate, ketones, such as acetone, methyl ethyl ketone, and methyl isobutyl ketone, aliphatic hydrocarbon, such as pentane, hexane, and octane, alicyclic hydrocarbon, such as cyclohexane, and methylcyclohexane, aromatic hydrocarbon, such as benzenes, having long-chain alkyl group, such as benzene, toluene, xylene, hexylbenzene, hebutylbenzene, octylbenzene, nonylbenzene, decylbenzene, undecylbenzene, dodecylbenzene, tridecylbenzene, and tetradecylbenzene, halogenated hydrocarbon, such as methylene chloride, chloroform, carbon tetrachloride, and 1,2-dichloroethane, carboxylate, and other various oils, either alone or in combination. The dispersion medium 81 may be mixed with a surface-active agent.

The white particles 82 are, for example, particles (polymer or colloid) formed of white pigment, such as titanium dioxide, zinc white (zinc oxide), and antimony trioxide, and are, for example, negatively charged.

The black particles 83 are, for example, particles (polymer or colloid) formed of black pigment, such as aniline black, and carbon black, and are, for example, positively charged.

For this reason, the white particles 82 and the black particles 83 are able to move in the dispersion medium 81 owing to an electric field that is generated by a potential difference between the pixel electrodes 21 and the common electrode 22.

These pigments may include additives such as electrolyte, surface active agent, metallic soap, resin, rubber, oil, varnish, charge control agent formed of particles such as compound, and dispersing agent, lubricant, stabilizing agent such as titanium-based coupling agent, aluminum-based coupling agent, and silane-based coupling agent, where necessary.

In FIG. 3 and FIG. 4, when a voltage is applied between the pixel electrode 21 and the common electrode 22 so that the potential of the common electrode 22 is relatively high, the positively-charged black particles 83 are attracted on the basis of Coulomb force toward the pixel electrode 21 in the microcapsule 80, while the negatively-charged white particles 82 are attracted on the basis of Coulomb force toward the common electrode 22 in the microcapsule 80. As a result, the white particles 82 gather on the display surface side (common electrode 22 side) in the microcapsule 80, and the color (white color) of the white particles 82 is displayed on the display surface of the display unit 3. Conversely, when a voltage is applied between the pixel electrode 21 and the common electrode 22 so that the potential of the pixel electrode 21 is relatively high, the negatively-charged white particles 82 are attracted on the basis of Coulomb force toward the pixel electrode 21, while the positively-charged black particles 83 are attracted on the basis of Coulomb force toward the pixel electrode 21. As a result, the black particles 83 gather on the display surface side of the microcapsule 80, and the color (black color) of the black particles 83 is displayed on the display surface of the display unit 3.

In addition, it is possible to display gray color, such as light gray, gray, or dark gray, which is a halftone between white color and black color by means of a dispersion state of the white particles 82 and the black particles 83 between the pixel electrode 21 and the common electrode 22. In addition, by replacing the pigments used for the white particles 82 and the black particles 83 with, for example, pigments, such as red color, green color, blue color, and the like, it is possible to perform color display, such as red color, green color, and blue color.

Hereinafter, a method of driving the electrophoretic display device according to the present embodiment will be described.

First, the normal display operation, other than an external input such as pen input, which will be described later, by the driving method according to the present embodiment will be described mainly with reference to FIG. 1 and FIG. 2.

As shown in FIG. 1 and FIG. 2, in the normal display operation, an image signal is written to each pixel 20, and then an image is displayed on the basis of the image signal.

In writing an image signal, the scanning line driving circuit 60 sequentially supplies a scanning signal to the scanning lines Y1, Y2, . . . , Ym, while the data line driving circuit 70 supplies image signals to the data lines X1, X2, . . . , Xn during a period in which one scanning line is selected on the basis of the scanning signal.

Thus, in each pixel 20, in accordance with the scanning signal, an image signal is input from the pixel switching transistor 24 to the input terminal N1 of the memory circuit 25.

At this time, the power supply circuit 210 supplies the high-level (for example, 5 V) high-potential power supply potential VEP and the low-level low-potential power supply potential Vss (for example, 0 V) in accordance with the potential levels (for example, a 5 V high level or a 0 V low level) of the image signals. The high-potential power supply potential VEP and the low-potential power supply potential Vss are respectively supplied through the turned-on switches 91s and 92s to the high-potential power supply line 91 and the low-potential power supply line 92. On the other hand, during a period in which image signals are written, the power supply circuit 210 and the common potential supply circuit 220 respectively do not supply the first potential S1 or the second potential S2 and the common potential Vcom and, therefore, the switches 93s, 94s and 95s are turned off. Thus, the common potential line 93, the first control line 94 and the second control line 95 all are in a high impedance state.

Subsequently, in each pixel 20, an image is displayed in accordance with the image signal as a process separated from the above writing of the image signal.

At this time, the power supply circuit 210 supplies the high-potential power supply potential VEP at a high level, which is, for example, boosted up from 5 V to 15 V (that is, the high-potential power supply potential VEP at the time when the image signal is written to the memory circuit 25 is boosted up from, for example, 5 V to 15 V), and supplies the low-potential power supply potential Vss (for example, 0 V) at a low level. In addition, the power supply circuit 210 supplies the first potential S1 at a high level (for example, 15 V), and supplies the second potential S2 at a low level (for example, 0 V). In this case, the second potential S2 is not supplied in a period during which the first potential S1 is supplied, and the first potential S1 is not supplied during which the second potential S2 is supplied.

Furthermore, the power supply circuit 210 preferably periodically varies the common potential Vcom to any one of the low level (for example, 0 V) and the high level (for example, 15 V) and then supplies the common potential Vcom. By so doing, so-called common oscillation driving is performed.

The thus supplied high-potential power supply potential VEP, low-potential power supply potential Vss, first potential S1, second potential S2 and common potential Vcom are supplied through the turned-on switches 91s, 92s, 93s, 94s and 95s to various lines 91, 92, 93, 94 and 95 shown in FIG. 2. However, in a period during which the first potential S1 is supplied, the first control line 94 is electrically connected through the switch 94s to the power supply circuit 210, and the second control line 95 is in a high impedance state because the corresponding switch 95s is turned off. On the other hand, in a period during which the second potential S2 is supplied, the second control line 95 is electrically connected through the switch 95s to the power supply circuit 210, and the first control line 94 is in a high impedance state because the corresponding switch 94s is turned off.

In the display unit 3, in each pixel 20, a low-level or high-level image signal is held in the memory circuit 25. Thus, in each pixel 20, on the basis of an output (the high-potential power supply potential VEP and the low-potential power supply potential Vss) from the memory circuit 25, one of the first transmission gate 111 and the second transmission gate 112 of the switch circuit 110 is turned on.

Specifically, in each of the pixels 20 to which a low-level image signal is input, only the first transmission gate 111 is turned on, and the pixel electrode 21 is electrically connected to the first control line 94. In addition, in each of the pixels 20 to which a high-level image signal is input, only the second transmission gate 112 is turned on, and the pixel electrode 21 is electrically connected to the second control line 95.

Thus, in each of the pixels 20 to which a low-level image signal is input, the first potential S1 (high level, for example, 15 V) is supplied from the first control line 94 to the pixel electrode 21, and black color is displayed on the basis of a potential difference that occurs with respect to the common electrode 22 when the common potential Vcom supplied from the common potential line 93 is at a low level (for example, 0 V). On the other hand, in each of the pixels 20 to which a high-level image signal is input, the second potential S2 (low level, for example, 0 V) is supplied from the second control line 95 to the pixel electrode 21, and white color is displayed on the basis of a potential difference that occurs with respect to the common electrode 22 when the common potential Vcom supplied from the common potential line 93 is at a high level (for example, 15 V).

In this manner, in the display unit 3 shown in FIG. 1, the pixels 20 each display an image on the basis of the first potential S1 or the second potential S2. In addition, after an image signal written to each pixel 20 as described above, the power supply circuit 210 boosts the high-potential power supply potential VEP up to, for example, 15 V to thereby increase a power supply voltage of the memory circuit 25 based on a potential difference between the high-potential power supply potential VEP and the low-potential power supply potential Vss, and then an image is displayed in such a manner that a potential difference between the pixel electrode 21 and the common electrode 22 is set to, for example, 15 V. Thus, in comparison with the case in which the memory circuit 25 is constantly driven at a voltage required to apply a predetermined potential difference between the pixel electrode 21 and the common electrode 22, it is possible to perform a display operation at a further low power consumption.

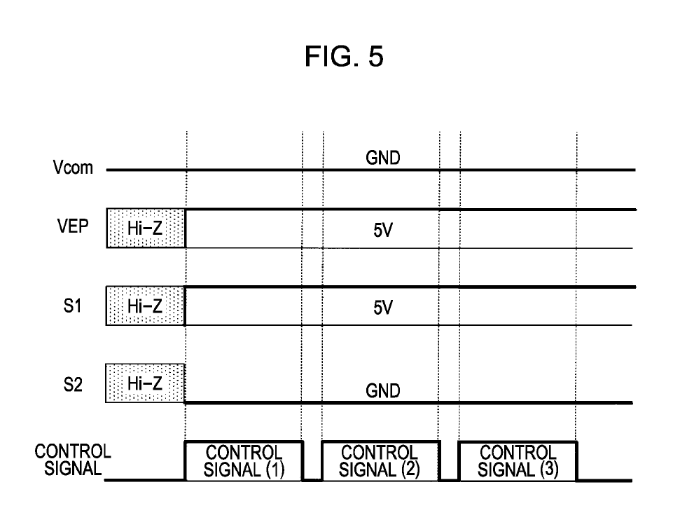

Next, a method of driving the electrophoretic display device 1 when the electrophoretic display device 1 is equipped with a pen tablet or a touch sensor and then an external input, such as a pen input, is performed will be described with reference to FIG. 5.

FIG. 5 is a timing chart that schematically shows the waveforms of various signals when an external input is performed.

As shown in FIG. 1, in the electrophoretic display device 1, a predetermined image based on a sequence in accordance with the above described series of display operations is displayed on the display unit 3. Note that, at this time, in an image displayed on the display unit 3, there is a case in which the contents corresponding to an external input that has been already performed is displayed together.

In FIG. 5, in a state where the predetermined image is thus displayed and an external input is waited, supply of various potentials VEP, Vss, and the like, from the power supply circuit 210 is desirably stopped, and various lines 91, 92, and the like, shown in FIG. 2 are in a high impedance state (Hi-Z). In addition, at the time of external input, the common potential supply circuit 220 desirably supplies the common potential Vcom at a predetermined potential, for example, a low level (ground level (GND), 0 V).

As an external input, such as pen input, is performed through a pen tablet, or the like, the controller 10 generates a control signal (in FIG. 5, control signal (1), control signal (2), control signal (3)) for each input, and then the scanning line driving circuit 60, the data line driving circuit 70, the power supply circuit 210 and the common potential supply circuit 220 are driven on the basis of the control signals. Thus, the contents corresponding to each input is displayed on the display unit 3 as described below.

At this time, on the basis of the control signal from the controller 10, writing of an image signal and image display corresponding to the image signal are performed in parallel with each other at the same time in each pixel 20. Specifically, in FIG. 5, after entering a state of waiting an external input, the control signal (1) is output from the controller 10 in accordance with a first external input. In FIG. 5, in accordance with the control signal (1), the power supply circuit 210 supplies the high-level (for example, 5 V) high-potential power supply potential VEP and the low-level low-potential power supply potential Vss (for example, 0 V), supplies the first potential S1 at a high level (for example, 5 V), and supplies the second potential S2 at a low level (for example, GND, 0V). Alternatively, in order to partially change display using black display, which will be described later, the power supply circuit 210 may be configured to not supply the second potential S2 but maintains the second control line 95 at a high impedance state (Hi-Z).

As shown in FIG. 5, the high-potential power supply potential VEP (and the low-potential power supply potential Vss), the first potential S1 and the second potential S2 are supplied from the power supply circuit 210 in parallel with one another at the same time after output of the control signal (1). Thus, the thus supplied high-potential power supply potential VEP (and the low-potential power supply potential Vss), the common potential Vcom, the first potential S1, and the second potential S2 are supplied in parallel with one another at the same time through the switches 91s, 92s, 93s, 94s and 95s to various lines 91, 92, 93, 94 and 95 shown in FIG. 2.

In addition, in accordance with the control signal (1), the scanning line driving circuit 60 and the data line driving circuit 70 are driven, and an image signal is written to the memory circuit 25 in each pixel 20 shown in FIG. 2.

When various potentials are supplied as shown in FIG. 5, that is, when the first potential S1 (for example, 5 V) is supplied to the pixel electrode 21 on the basis of the image signal as described above, black display is possible in the pixel 20 on the basis of a potential difference with respect to the common potential Vcom (for example, 0 V) of the common electrode 22. However, when the second potential S2 (for example, 0 V) is supplied to the pixel electrode 21, there occurs no potential difference with respect to the common potential Vcom (for example, 0 V) of the common electrode 22. That is, in the present embodiment, only the display change using black display in accordance with an external input is possible. The scanning line driving circuit 60 and the data line driving circuit 70 are desirably driven on the basis of the control signal (1), and low-level image signals are supplied to only the pixels 20 located at positions of the display unit 3, required to change the display contents in accordance with the external input.

In this case, in each of the pixels 20 to which the low-level image signal is input, in accordance with an output from the memory circuit 25, based on the image signal, the first transmission gate 111 of the switch circuit 110 turns on to electrically connect the pixel electrode 21 to the first control line 94.

In parallel with writing of an image to the memory circuit 25, the above described first control line 94 and second control line 95 are supplied with the first potential S1 and the second potential S2. Thus, in parallel with writing of the image signal to the memory circuit 25, in each of the pixels 20 to which a low-level image signal is input, the first potential S1 (high level, for example, 5 V) is supplied from the first control line 94 to the pixel electrode 21, and then black display is performed on the basis of a potential difference between the pixel electrode 21 and the common electrode 22.

In FIG. 5, for the control signals (2) and (3) output from the controller 10 in the second and following external inputs as well, in accordance with each of the control signals, the similar display operation as that of the control signal (1) is performed, and display change using black display is performed only at necessary positions on the display unit 3 in regard to the contents corresponding to each input.

Thus, in the present embodiment, the length of time required from writing of an image signal until display at the time of external input may be shorter than the case in which display is performed as a process that is separated from writing of an image signal as described above and, therefore, it is possible to quickly display the contents corresponding to an external input on the display unit 3. Thus, in synchronization with an external input, an image in response to the contents of the input may be displayed.

Here, when only necessary portions corresponding to an external input are changed as described above, in comparison with the case in which an image on the entire display unit 3 is switched in accordance with the contents of an input, it is possible to quickly display an image in response.

In addition, as described with reference to FIG. 5, at the time of an external input, different from a normal display operation, the high-potential power supply potential VEP is maintained, for example, at 5 V, and the power supply voltage of the memory circuit 25 is not boosted up. Thus, it is possible to perform display in parallel with writing of an image in each pixel 20 at the same time at a low power consumption.

Note that when the voltage is not boosted up, as described with reference to FIG. 5, a potential difference between the pixel electrode 21 and the common electrode 22 is, for example, 5 V. Thus, as the potential difference between the pixel electrode 21 and the common electrode 22 reduces (during normal display operation, for example, 15 V), the white particles 82 and the black particle 83, which are described with reference to FIG. 4, are not smoothly moved and, therefore, there is a possibility that a decrease in contrast, or the like, occurs and then display quality degrades. However, when only the necessary portions are changed as described above, it is possible to prevent degradation of display quality of the entire image displayed on the display unit 3.

Alternatively, in order to prevent such degradation of display quality, it is applicable that driving voltages of the data line driving circuit 70, the scanning line driving circuit 60, and the like, are adjusted, and the high-potential power supply potential VEP and the first potential S1 both are maintained at, for example, 15 V to thereby perform display corresponding to an external input.

The case in which display is partially changed using black display in accordance with an external input is described with reference to FIG. 5; instead, display may be partially changed using white display. In this case, for example, in accordance with a control signal, the common potential Vcom (for example, 5 V) is supplied from the common potential supply circuit 220 so that a potential difference is generated with respect to the second potential S2 (for example, GND, 0 V).

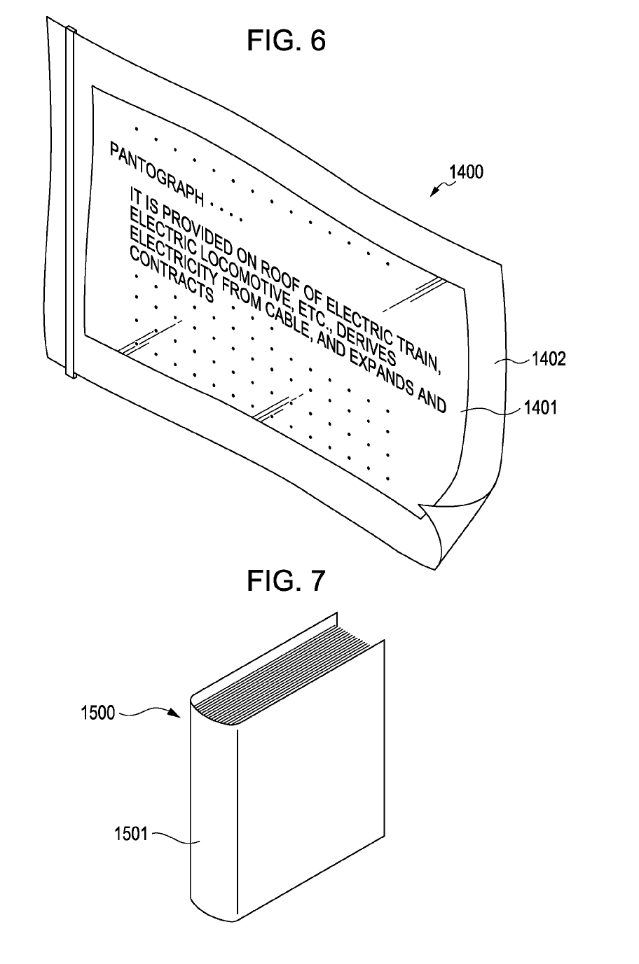

Next, electronic apparatuses that employ the above described electrophoretic display device will be described with reference to FIG. 6 and FIG. 7. Hereinafter, an example in which the above described electrophoretic display device is applied to an electronic paper and an electronic notebook will be described.

FIG. 6 is a perspective view that shows the configuration of an electronic paper 1400.

As shown in FIG. 6, the electronic paper 1400 includes the electrophoretic display device according to the above described embodiment as a display unit 1401. The electronic paper 1400 is flexible and has a body 1402 formed of a rewritable sheet having a texture and flexibility similar to an existing paper.

FIG. 7 is a perspective view that shows the configuration of an electronic notebook 1500.

As shown in FIG. 7, the electronic notebook 1500 is configured so that the multiple sheets of electronic paper 1400 shown in FIG. 6 are bound and fastened with a cover 1501. The cover 1501 is provided with a display data input device (not shown) that is used to input display data sent from, for example, an external device. Thus, in accordance with the display data, it is possible to change or update the contents of display while the electronic papers are bound.

Because the above described electronic paper 1400 and electronic notebook 1500 each include th electrophoretic display device according to the above described embodiment, power consumption is small, and it is possible to perform high-quality image display.

Note that, other than the above, the display unit of an electronic apparatus, such as a watch, a cellular phone, or a portable audio device, may employ the electrophoretic display device according to the above described embodiment.

The aspects of the invention are not limited to the embodiment described above; they may be modified appropriately without departing from the scope or spirit of the invention that can be read from the appended claims and entire specifications. The aspects of the invention also encompass the thus modified electrophoretic display device, method of driving the same, and electronic apparatus provided with the electrophoretic display device.

The entire disclosure of Japanese Patent Application No. 2008-083236, filed Match 27, 2008 is expressly incorporated by reference herein.

What is claimed is:

1. A method of driving an electrophoretic display device that includes a display unit that includes a plurality of pixels, each of which includes a pair of a pixel electrode and a common electrode; an electrophoretic element that is driven on the basis of a potential difference between the pixel electrode and the common electrode; a pixel switching element; a memory circuit; and a switch circuit, the method comprising:
writing an image signal to the memory circuit through the pixel switching element; and
displaying a predetermined image on the display unit by performing a switching control by the switch circuit in accordance with an output based on the image signal of the memory circuit to supply a predetermined potential to the pixel electrode, wherein
at least when the electrophoretic element is driven in accordance with an external input from outside of the electrophoretic display device, the predetermined image is displayed on the display unit in parallel with the writing of the image signal to the memory circuit at the same time.

2. The method of driving the electrophoretic display device according to claim 1, further comprising:
supplying a boosted power supply voltage to the memory circuit between when the image signal is written to the memory circuit and when the predetermined image is displayed on the display unit, wherein
the boosted power supply voltage is not supplied to the memory circuit at least when the external input is performed.

3. The method of driving the electrophoretic display device according to claim 1, wherein,
when the predetermined is displayed on the display unit, any one of the first and second potentials is supplied through the switch circuit to the pixel electrode by the switching control, while
at least at the time of the external input, the common electrode is supplied with a common potential so that a potential difference occurs between the common potential and only any one of the first and second potentials.

4. An electrophoretic display device that is driven by the method of driving the electrophoretic display device according to claim 1.

5. An electronic apparatus comprising the electrophoretic display device according to claim 4.
